(19) United States
(12) Patent Application Publication
(10) Pub. No.: US 2021/0227835 A1
(43) Pub. Date: Jul. 29, 2021

(54) FORMULATIONS COMPRISING NATURAL HYDROSOLS AND USES THEREOF

(71) Applicant: Bio-Cloud Ltd, Kfar-Vradim (IL)

(72) Inventor: Yoav NITZAV, Kfar-Vradim (IL)

(73) Assignee: Bio-Cloud Ltd, Kfar-Vradim (IL)

(21) Appl. No.: 17/053,362

(22) PCT Filed: May 7, 2019
(86) PCT No.: PCT/IB2019/053744

§ 371 Date: Nov. 6, 2020

(30) Foreign Application Priority Data
May 7, 2018 (IL) 259193

(51) Int. Cl. A01N 65/22; A01N 65/44; A01N 27/00; A01N 65/26; A01N 65/06; A01N 31/06; A01N 65/28

(52) U.S. Cl. CPC A01N 65/22; A01N 65/44; A01N 27/00; A01N 65/28; A01N 65/06; A01N 31/06; A01N 65/26

(57) ABSTRACT

Formulations comprising at least one hydrosol are described herein, which may optionally be associated with a polymeric matrix. The hydrosol may include rosemary hydrosol, lemongrass hydrosol, azedarach hydrosol, Azadirachta indica hydrosol, tea tree hydrosol, pine hydrosol and/or a basil hydrosol. Further described herein are methods and uses of the formulations for controlling a pest population, and kits and articles of manufacture comprising such formulations.

### RELATED APPLICATIONS

This application claims the benefit of priority of Israel Application No. 259193 filed May 7, 2018, the contents of which are incorporated by reference as if fully set forth herein.

### FIELD AND BACKGROUND OF THE INVENTION

The present invention, in some embodiments thereof, relates to formulations comprising natural products, and more particularly, but not exclusively, to formulations comprising natural hydrosols and uses thereof in controlling pests.

Reducing crop damage caused by pests is a growing challenge in the developing world. Synthetic insecticides or fungicides are often non-specific, toxic and non-biodegradable. In addition, their use results in selection of resistant microorganisms.

Natural formulations for use in pest control have been described in Nadia et al. [Res Chem Intermed 2016, 42:1639-1649], which describes insecticidal effects of mint hydrosols against Toxoptera aurantii; and Petrakis et al. [J Appl Entomol 2015, 139:260-267], which describes insecticidal and settling inhibition potential of hydrosols against Myzus persicae.

Additional background art includes U.S. Patent Application No. 2004/0178054.

### SUMMARY OF THE INVENTION

According to an aspect of some embodiments of the invention, there is provided a formulation comprising at least one hydrosol.

According to an aspect of some embodiments of the invention, there is provided a formulation comprising at least one hydrosol selected from the group consisting of a rosemary hydrosol, a lemongrass hydrosol, an azedarach hydrosol, an Azadirachta indica hydrosol, a tea tree hydrosol, a pine hydrosol and a basil hydrosol.

According to an aspect of some embodiments of the invention, there is provided a method of controlling a pest population, the method comprising applying to a pest population or to the loci or surroundings thereof, a formulation according to any of the respective embodiments described herein.

According to an aspect of some embodiments of the invention, there is provided a kit comprising the formulation according to any of the respective embodiments described herein.

According to an aspect of some embodiments of the invention, there is provided a composition-of-matter comprising:

a formulation which comprises at least one hydrosol (according to any of the respective embodiments described herein), and

a polymeric matrix with which at least a portion of the formulation is associated.

According to an aspect of some embodiments of the invention, there is provided a method of controlling a pest population, the method comprising applying to a pest population or to the loci or surroundings thereof, a composition-of-matter according to any of the respective embodiments described herein.

According to an aspect of some embodiments of the invention, there is provided an article of manufacture comprising a formulation according to any of the respective embodiments described herein.

According to an aspect of some embodiments of the invention, there is provided an article of manufacture comprising a composition-of-matter according to any of the respective embodiments described herein.

According to some of any of the embodiments of the invention, the formulation comprises at least one hydrosol selected from the group consisting of a rosemary hydrosol, a lemongrass hydrosol, an azedarach hydrosol, an Azadirachta indica hydrosol, a tea tree hydrosol, a pine hydrosol and a basil hydrosol.

According to some of any of the embodiments of the invention, the formulation comprises at least two hydrosols selected from the group consisting of a rosemary hydrosol, a lemongrass hydrosol, an Azadirachta indica hydrosol and a tea tree hydrosol.

According to some of any of the embodiments of the invention, the formulation comprises at least two hydrosols selected from the group consisting of a rosemary hydrosol, a lemongrass hydrosol, an azedarach hydrosol and a tea tree hydrosol.

According to some of any of the embodiments of the invention, the formulation comprises at least two hydrosols selected from the group consisting of a rosemary hydrosol, a pine hydrosol and a basil hydrosol.

According to some of any of the embodiments of the invention, the formulation comprises from 10% to 80% of rosemary hydrosol, from 10% to 80% of lemongrass hydrosol, from 1% to 50% of azedarach hydrosol and from 5% to 50% of tea tree hydrosol.

According to some of any of the embodiments of the invention, the formulation comprises from 10% to 80% of rosemary hydrosol, from 10% to 80% of lemongrass hydrosol, from 1% to 50% of Azadirachta indica hydrosol and from 5% to 50% of tea tree hydrosol.

According to some of any of the embodiments of the invention, the formulation comprises 10% to 50% of rosemary hydrosol, from 30% to 80% of lemongrass hydrosol, from 1% to 15% of azedarach hydrosol and from 10% to 25% of tea tree hydrosol.

According to some of any of the embodiments of the invention, the formulation comprises from 10% to 50% of rosemary hydrosol, from 30% to 80% of lemongrass hydrosol, from 1% to 15% of Azadirachta indica hydrosol and from 10% to 25% of tea tree hydrosol.

According to some of any of the embodiments of the invention, the formulation comprises at least one compound selected from the group consisting of γ-terpinene, δ-2-carene, p-cymene, α-pinene, terpinolene and terpinen-4-ol.

According to some of any of the embodiments of the invention, the formulation comprises from 5% to 95% γ-terpinene.

According to some of any of the embodiments of the invention, the formulation comprises from 5% to 95% δ-2-carene.

According to some of any of the embodiments of the invention, the formulation comprises from 5% to 95% p-cymene.

According to some of any of the embodiments of the invention, the formulation comprises from 1% to 30% essential oil by weight.

According to some of any of the embodiments of the invention relating to a formulation, the formulation is formulated for administration by spraying and/or dripping.

According to some of any of the embodiments of the invention, the formulation is associated with a polymeric matrix.

According to some of any of the embodiments of the invention, the formulation is for use in control of a pest population.

According to some of any of the embodiments of the invention, the formulation is for use in repelling and/or killing a pest selected from the group consisting of ectoparasites, oomycetes, insects, mites, fungi, bacteria, viruses, virus-like organisms, nematodes, gastropods, protozoa, phytopathogens and phytoplasmas.

According to some of any of the embodiments of the invention, the formulation is for use in repelling and/or killing a pest selected from the group consisting of Bemisia tabaci, Spodoptera littoralis and Myzus persicae.

According to some of any of the embodiments of the invention relating to a composition-of-matter, the composition-of-matter is use in control of a pest population.

According to some of any of the embodiments of the invention relating to a composition-of-matter, the composition-of-matter is use in repelling and/or killing a pest selected from the group consisting of ectoparasites, oomycetes, insects, mites, fungi, bacteria, viruses, virus-like organisms, nematodes, gastropods, protozoa, phytopathogens and phytoplasmas.

According to some of any of the embodiments of the invention relating to a composition-of-matter, the composition-of-matter is use in repelling and/or killing a pest selected from the group consisting of Bemisia tabaci, Spodoptera littoralis and Myzus persicae.

According to some of any of the embodiments of the invention relating to a method, the method is for repelling and/or killing a pest selected from the group consisting of ectoparasites, oomycetes, insects, mites, fungi, bacteria, viruses, virus-like organisms, nematodes, gastropods, protozoa, phytopathogens and phytoplasmas.

According to some of any of the embodiments of the invention relating to a method, the method is for repelling and/or killing a pest selected from the group consisting of Bemisia tabaci, Spodoptera littoralis and Myzus persicae.

According to some of any of the embodiments of the invention relating to a kit, the kit comprises instructions for use of the formulation in control of a pest population.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 presents a graph showing the effect of a formulation according to some embodiments of the invention on whitefly infection of cauliflower (y-axis indicates number of whiteflies).

FIGS. 2A and 2B present graphs showing the amount (mass) of active material in a polymer matrix (according to some embodiments of the invention) as a function of time (FIG. 2A), and the and rate of release of the active material from the polymer matrix as a function of time (FIG. 2B).

### DESCRIPTION OF SPECIFIC EMBODIMENTS OF THE INVENTION

The present invention, in some embodiments thereof, relates to formulations comprising natural products, and more particularly, but not exclusively, to formulations comprising natural hydrosols and uses thereof in controlling pests.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

The present disclosure is aimed at developing agriculture formulations comprising natural-based components that are highly effective in reducing crop damage while being non-toxic and less susceptible to development of crop resistance. The formulations developed herein can provide an alternative to conventional pesticides/insecticides.

Specifically, the inventor has developed formulations comprising natural isolate such as hydrosols from plants, found to be effective against a variety of pest populations, either when administrated by known methods such as dripping, spraying and the like or when being associated with a polymeric matrix.

According to an aspect of some embodiments of the invention, there is provided a formulation comprising at least one hydrosol, which is optionally for use in control of a pest population, and specifically a plant pest population.

The term “pest” as used herein refers to an organism being detrimental to humans or human concerns including plant, crops and forestry.

The term “plant pest” may be understood in accordance with the definition in terms of the International Plant Protection Convention and phytosanitary measures worldwide and refers to any species, strain or biotype of plant, animal, or pathogenic agent injurious to plants or plant products.

Non-liming examples of plant pests include ectoparasites, oomycetes insects, mites, fungi, bacteria, viruses, virus-like organisms, nematodes, gastropods, protozoa, phytopathogens or phytoplasmas or any other injurious animal to humans, animals or plant varieties including parasitic plants.

As shown in the Examples below, exemplary formulations had a repelling effect on the growth of crop, namely preventing and controlling the outbreak of disease caused by pest populations. As further shown in the Examples below, the exemplary formulation, per se or associated with a matrix, has a killing activity comparable to that of chemical pest control compositions, without exhibiting the toxicity commonly associated with such chemical compositions. Furthermore, it was shown that the formulation was effective for a long time, at least a week and thus can be used as a sustained release formulation having a prolonged repelling and/or killing effect.

Without being bound by theory, it was suggested that formulation may be effective via various profiles including a rapid release followed by a sustained/slow/delayed release or only a sustained/slow/delayed release, providing a prolonged effect/activity of the formulation.

Herein and in the art, the term “hydrosol” refers to a volatile component of a natural material (e.g., of a plant or portion thereof), optionally comprising aroma-bearing compounds. A hydrosol is preferably prepared by steam distillation of the natural material (e.g., at atmospheric pressure), optionally following soaking of the natural material in water. The hydrosol optionally comprises water and a water-insoluble fraction of a condensate obtained from steam distillation (e.g., a water-insoluble fraction which is dispersed in and/or floats on a surface of the aqueous fraction of the condensate).

The hydrosol can be produced from plants and is found in various parts of the plant such as: leaves, stems, seeds, flowers, fruits or roots. The hydrosol may be produced from any plant such as a flowering plant, tree, conifer, gymnosperm, fern, clubmosses, hornworts, liverworts and/or mosses. For example, the hydrosol may be produced from a tree, a flowering plant or an herb plant. The hydrosol may be produced from a plant as a whole, or from one or more parts thereof, including leaves, stems, seeds, flowers, fruits or roots. In addition, the hydrosol may be produced from a fresh plant (e.g. as a whole plant) or the plant may be a priori processed by any one of drying, semi-drying, cutting, chopping, grinding, powdering and the like.

The hydrosol may be produced by various methods known in the art, such as steam distillation or extraction. The hydrosol is often produced in parallel to production of essential oils, which are the oil-soluble constituents and the hydrosol may be collected as the aqueous product of the production process. In some embodiment, the hydrosol is produced by steam distillation, preferably at a temperature of at least 100° C. or a t least 200° C. It should be noted that a formulation as described herein may comprise at least two hydrosols and may be produced either by combing different formulations each comprising a different hydrosol or by distillation or extraction together a combination of various plants or plant parts.

In some of any of the embodiments described herein, a (total) concentration of organic compounds in the hydrosol(s) is at least 0.1% by weight, optionally from 0.1% to 20%, or from 0.1% to 5%, or from 0.1% to 1%, or from 0.1% to 0.3%. In some embodiments, a concentration of organic compounds in the hydrosol(s) is at least 0.3% by weight, optionally from 0.3% to 20%, or from 0.3% to 5%, or from 0.3% to 1%. In some embodiments, a concentration of organic compounds in the hydrosol(s) is at least 1% by weight, optionally from 1% to 20%, or from 1% to 5%, including any intermediate values and subranges therebetween. In some embodiments, a concentration of organic compounds in the hydrosol(s) is at least 5% by weight, optionally from 5% to 20%.

A hydrosol according to any of the embodiments described herein may be produced from a variety of plants. Non-limiting examples include artemisias, azedarach, Azadirachta indica, basil, borage, castor bean, catnip, chamomile, chives, chrysanthemums, cinnamon, citronella grass, clovers, common lantana, coriander, cosmos, crown imperial, dahlias, dill, eucalyptus, fennel, fever tea, four o'clocks, French marigold, garlic, geraniums, hyssop, larkspurs, lavender, leek, lemongrass, lemon balm, lemon thyme, lettuce, lime basil, Mexican marigold, myrrh, narcissus, nasturtiums, onion, oregano, parsley, peppermint, petunias, pine, pitcher plants, radish, rosemary, rue, spearmint, spiny amaranth, stone root, summer savory, tansy, tea tree, thyme, tobacco, tomato and/or venus flytrap.

In some embodiments, the formulation comprises at least one hydrosol, at least two different hydrosols, at least three different hydrosols, at least four different hydrosols, at least five different hydrosols, or at least six different hydrosols. By “different hydrosols” it is meant hydrosols that differ from one another by the chemical composition of the organic compound(s) and/or by an amount of one or more of the organic compound(s) and/or by the type of plant from which the hydrosol is produced or originates.

Reference herein to a plurality of hydrosols refers to hydrosols produced from a plurality of different plants.

In some embodiments, the formulation comprises one hydrosol or a combination of two, three or four different hydrosols.

In some embodiments, the hydrosol is a rosemary hydrosol. In some embodiments, the hydrosol is a lemongrass hydrosol. In some embodiments, the hydrosol is an azedarach hydrosol.

In some embodiments, the hydrosol is an Azadirachta indica hydrosol. In some embodiments, the hydrosol is a tea tree hydrosol. In some embodiments, the hydrosol is a pine hydrosol. In some embodiments, the hydrosol is a basil hydrosol. A plant hydrosol is denoted by the plant from which it is being produced. For example, a basil hydrosol is a hydrosol produced from basil.

In some embodiments, the formulation comprises at least one hydrosol from rosemary. In some embodiments, the formulation comprises at least one hydrosol from lemongrass. In some embodiments, the formulation comprises at least one hydrosol from Azadirachta indica. In some embodiments, the formulation comprises at least one hydrosol from tea tree. In some embodiments, the formulation comprises at least one hydrosol from azedarach.

In some embodiments, the formulation comprises rosemary hydrosol and lemongrass hydrosol. In some such embodiments, the formulation further comprises Azadirachta indica hydrosol, azedarach hydrosol, tea tree hydrosol, pine hydrosol and/or basil hydrosol, optionally Azadirachta indica hydrosol, azedarach hydrosol and/or tea tree hydrosol.

In some embodiments, the formulation comprises rosemary hydrosol and Azadirachta indica hydrosol. In some such embodiments, the formulation further comprises lemongrass hydrosol, azedarach hydrosol, tea tree hydrosol, pine hydrosol and/or basil hydrosol, optionally lemongrass hydrosol, azedarach hydrosol and/or tea tree hydrosol.

In some embodiments, the formulation comprises rosemary hydrosol and tea tree hydrosol. In some such embodiments, the formulation further comprises Azadirachta indica hydrosol, azedarach hydrosol, lemongrass hydrosol, pine hydrosol and/or basil hydrosol, optionally Azadirachta indica hydrosol, azedarach hydrosol and/or lemongrass hydrosol.

In some embodiments, the formulation comprises lemongrass hydrosol and tea tree hydrosol. In some such embodiments, the formulation further comprises Azadirachta indica hydrosol, azedarach hydrosol, rosemary hydrosol, pine hydrosol and/or basil hydrosol, optionally Azadirachta indica hydrosol, azedarach hydrosol and/or rosemary hydrosol.

In some embodiments, the formulation comprises lemongrass hydrosol and Azadirachta indica hydrosol. In some such embodiments, the formulation further comprises rosemary hydrosol, azedarach hydrosol, tea tree hydrosol, pine hydrosol and/or basil hydrosol, optionally rosemary hydrosol, azedarach hydrosol and/or tea tree hydrosol.

In some embodiments, the formulation comprises Azadirachta indica hydrosol and tea tree hydrosol. In some such embodiments, the formulation further comprises rosemary hydrosol, azedarach hydrosol, lemongrass hydrosol, pine hydrosol and/or basil hydrosol, optionally rosemary hydrosol, azedarach hydrosol and/or lemongrass hydrosol.

In some embodiments, the formulation comprises rosemary hydrosol, lemongrass hydrosol and Azadirachta indica hydrosol. In some such embodiments, the formulation further comprises tea tree hydrosol, azedarach hydrosol, pine hydrosol and/or basil hydrosol, optionally tea tree hydrosol and/or azedarach hydrosol.

In some embodiments, the formulation comprises rosemary hydrosol, lemongrass hydrosol and tea tree hydrosol. In some such embodiments, the formulation further comprises Azadirachta indica hydrosol, azedarach hydrosol, pine hydrosol and/or basil hydrosol, optionally Azadirachta indica hydrosol and/or azedarach hydrosol.

In some embodiments, the formulation lemongrass hydrosol, tea tree hydrosol and Azadirachta indica hydrosol. In some such embodiments, the formulation further comprises rosemary hydrosol, azedarach hydrosol, pine hydrosol and/or basil hydrosol, optionally rosemary hydrosol and/or azedarach hydrosol.

In some embodiments, the formulation comprises rosemary hydrosol, lemongrass hydrosol, Azadirachta indica hydrosol and tea tree hydrosol.

In some embodiments, the formulation comprises rosemary hydrosol, pine hydrosol and basil hydrosol.

In some embodiments, the formulation comprises a combination of hydrosols, selected from the group consisting of rosemary hydrosol, lemongrass hydrosol, azedarach hydrosol and tea tree hydrosol.

In some embodiments, the formulation comprises a combination of hydrosols, selected from the group consisting of rosemary hydrosol, lemongrass hydrosol, Azadirachta indica hydrosol and tea tree hydrosol.

In some embodiments, the formulation comprises a combination of hydrosols, selected from the group consisting of rosemary hydrosol, pine hydrosol and basil hydrosol.

Herein, the term “rosemary” encompasses Rosmarinus spp., for example, Rosmarinus officinalis.

Herein, the term “lemongrass” encompasses Cymbopogon spp., for example, Cymbopogon citratus.

Herein, “Azadirachta indica” refers to neem, including all varieties thereof.

Herein, the term “azedarach” encompasses Melia azedarach, including all varieties thereof.

Herein, the term “tea tree” encompasses Melaleuca spp., for example, Melaleuca alternifolia and Melaleuca cajaputi.

Herein, the term “pine” encompasses all plants in the family Pinaceae, for example, species of Pinus spp.

Herein, the term “basil” encompasses Ocimum spp., for example, Ocimum basilicum, including all varieties thereof.

The formulation preferably comprises an effective amount of the at least one hydrosol according to any of the respective embodiments described herein. The term “effective amount” as used herein may be determined by conditions/tests/experiments known to a skilled person in the art. The amount is sufficient to reduce plant damage caused by pest, control pest (repel and/or kill). In some embodiments, the formulation comprises from 2% to 98% w/w or v/v or w/v hydrosol from rosemary, optionally from 5% to 95%, optionally from 10% to 90%, optionally 20% to 80%, optionally 30% to 70%, optionally 40% to 60%, optionally at least 10%, optionally at least 20%, optionally at least 25%, optionally at least 30%, optionally at least 40%, optionally at least 50%, optionally at least 60%, optionally at least 70%, optionally at least 80%, optionally at least 90%, and optionally at least 95% hydrosol from rosemary.

In some embodiments, the formulation comprises from 2% to 98% w/w or v/v or w/v hydrosol from lemongrass, optionally from 5% to 95%, optionally from 10% to 90%, optionally 20% to 80%, optionally 30% to 70%, optionally 40% to 60%, optionally at least 10%, optionally at least 20%, optionally at least 25%, optionally at least 30%, optionally at least 40%, optionally at least 50%, optionally at least 60%, optionally at least 70%, optionally at least 80%, optionally at least 90%, and optionally at least 95% hydrosol from lemongrass.

In some embodiments, the formulation comprises from 2% to 98% w/w or v/v or w/v hydrosol from azedarach, optionally from 5% to 95%, optionally from 10% to 90%, optionally 20% to 80%, optionally 30% to 70%, optionally at least 10%, optionally at least 20%, optionally at least 25%, optionally at least 30%, optionally at least 40%, optionally at least 50%, optionally at least 60%, optionally at least 70%, optionally at least 80%, optionally at least 90%, optionally at least 95% hydrosol from azedarach.

In some embodiments, the formulation comprises from 2% to 98% w/w or v/v or w/v hydrosol from tea tree, optionally from 5% to 95%, optionally from 10% to 90%, optionally 20% to 80%, optionally 30% to 70%, optionally at least 10%, optionally at least 20%, optionally at least 25%, optionally at least 30%, optionally at least 40%, optionally at least 50%, optionally at least 60%, optionally at least 70%, optionally at least 80%, optionally at least 90%, and optionally at least 95% hydrosol from tea tree.

In some embodiments, the formulation comprises from 2% to 98% w/w or v/v or w/v hydrosol from pine, optionally from 5% to 95%, optionally from 10% to 90%, optionally 20% to 80%, optionally 30% to 70%, optionally at least 10%, optionally at least 20%, optionally at least 25%, optionally at least 30%, optionally at least 40%, optionally at least 50%, optionally at least 60%, optionally at least 70%, optionally at least 80%, optionally at least 90%, and optionally at least 95% hydrosol from pine.

In some embodiments, the formulation comprises from 2% to 98% w/w or v/v or w/v hydrosol from basil, optionally from 5% to 95%, optionally from 10% to 90%, optionally 20% to 80%, optionally 30% to 70%, optionally at least 10%, optionally at least 20%, optionally at least 25%, optionally at least 30%, optionally at least 40%, optionally at least 50%, optionally at least 60%, optionally at least 70%, optionally at least 80%, optionally at least 90%, and optionally at least 95% hydrosol from basil.

In some embodiments, the formulation comprises from 2% to 98% w/w or v/v or w/v hydrosol from Azadirachta indica, optionally from 5% to 95%, optionally from 10% to 90%, optionally 20% to 80%, optionally 30% to 70%, optionally at least 10%, optionally at least 20%, optionally at least 25%, optionally at least 30%, optionally at least 40%, optionally at least 50%, optionally at least 60%, optionally at least 70%, optionally at least 80%, optionally at least 90%, and optionally at least 95% hydrosol from Azadirachta indica.

In some embodiments, the formulation comprises equal amounts of the hydrosol. In some embodiments, the formulation comprises about 25% of rosemary hydrosol, about 25% of lemongrass hydrosol, about 25% of azedarach hydrosol and about 25% of tea tree hydrosol.

In some embodiments, the formulation comprises equal amounts of the hydrosol. In some embodiments, the formulation comprises about 25% of rosemary hydrosol, about 25% of lemongrass hydrosol, about 25% of Azadirachta indica hydrosol and about 25% of tea tree hydrosol.

In some embodiments, the formulation comprises about 20% of rosemary hydrosol, about 20% of lemongrass hydrosol, about 20% of Azadirachta indica hydrosol, about 20% of azedarach hydrosol and about 20% tea tree hydrosol.

In some embodiments, the formulation comprises about 33% of rosemary hydrosol, about 33% of pine hydrosol and about 33% of basil hydrosol.

In some embodiments, the formulation comprises about 33% of rosemary hydrosol, about 33% of lemon grass hydrosol and about 33% of basil hydrosol.

In some embodiments, the formulation comprises about 33% of rosemary hydrosol, about 33% of Azadirachta indica hydrosol and about 33% of basil hydrosol.

In some embodiments, the formulation comprises different amounts of each one of the hydrosol.

In some embodiments, the formulation comprises from 10% to 80%% of rosemary hydrosol, from 10% to 80% of lemongrass hydrosol, from 1% to 50% of azedarach hydrosol and from 5% to 50% of tea tree hydrosol.

In some embodiments, the formulation comprises from 10% to 40%% of rosemary hydrosol, from 40% to 80% of lemongrass hydrosol, from 1% to 20% of azedarach hydrosol and from 5% to 30% of tea tree hydrosol.

In some embodiments, the formulation comprises from 50% to 80%% of rosemary hydrosol, from 10% to 40% of lemongrass hydrosol, from 20% to 50% of azedarach hydrosol and from 30% to 50% of tea tree hydrosol.

In some embodiments, the formulation comprises from 10% to 80%% of rosemary hydrosol, from 10% to 80% of lemongrass hydrosol, from 1% to 50% of Azadirachta indica hydrosol and from 5% to 50% of tea tree hydrosol.

In some embodiments, the formulation comprises from 10% to 40%% of rosemary hydrosol, from 40% to 80% of lemongrass hydrosol, from 1% to 20% of Azadirachta indica hydrosol and from 5% to 30% of tea tree hydrosol.

In some embodiments, the formulation comprises from 50% to 80%% of rosemary hydrosol, from 10% to 40% of lemongrass hydrosol, from 20% to 50% of Azadirachta indica hydrosol and from 30% to 50% of tea tree hydrosol.

In some embodiments, the formulation comprises from 10% to 80%% of rosemary hydrosol, from 10% to 80% of lemongrass hydrosol, from 1% to 50% of Azadirachta indica hydrosol, 1% to 50%, azedarach hydrosol and from 5% to 50% of tea tree hydrosol.

In some embodiments, the formulation comprises from 10% to 40%% of rosemary hydrosol, from 40% to 80% of lemongrass hydrosol, from 1% to 20% of Azadirachta indica hydrosol, from 1% to 20% of azedarach hydrosol and from 5% to 30% of tea tree hydrosol.

In some embodiments, the formulation comprises from 50% to 80%% of rosemary hydrosol, from 10% to 40% of lemongrass hydrosol, from 20% to 50% of Azadirachta indica hydrosol from 20% to 50% of azedarach hydrosol and from 30% to 50% of tea tree hydrosol. In some embodiments, the formulation comprises from 10% to 80% of rosemary hydrosol, from 10% to 80% of lemongrass hydrosol, from 2% to 50% of azedarach hydrosol and from 5% to 50% tea tree hydrosol.

In some embodiments, the formulation comprises different amounts of each one of the hydrosol. In some embodiments, the formulation comprises from 10% to 80% of rosemary hydrosol, from 10% to 80% of lemongrass hydrosol, from 2% to 50% of Azadirachta indica hydrosol and from 5% to 50% tea tree hydrosol.

In some other embodiments, the formulation comprises synergistic amounts of the hydrosols. In some embodiments, the formulation comprises at least two, at least three or at least four of the hydrosol, each one in a synergistic effective amount. In some embodiments, the formulation comprises a combination of at least two, at least three or even four different hydrosols, each one in a synergistic effective amount (synergistic weight ratio).

Herein, a “synergistic amount” refers to a quantity of a combination of at least two hydrosols that is statistically significantly more effective against a pest than the corresponding two hydrosols when administered individually (e.g., not in combination). The synergistic amount is defined as an amount providing a synergistic effect. A synergistic effect may be calculated by any known method in the art (for example, by determining tribology behavior).

Each hydrosol comprises measurable “active substances”, suggested to be the substances or components of the hydrosol that are responsible for the activity of the hydrosol in the formulation as pest control. In this context it is to be appreciated that only a portion of the hydrosol from a plant constitutes the active substances. The amount of active substances in a hydrosol may be determined by analytical methods, such as high performance liquid chromatography (HPLC), chromatography, spectroscopy and the like.

When referring to “active substances”, the term is to be understood as encompassing a natural substance obtained from a plant as detailed herein as well as any synthetic or semi-synthetic analog thereof having a biological activity corresponding to the activity of the natural substance (the natural, synthetic or semi-synthetic isolate being regarded as active ingredient, active material, active component of the plant). In the context of the present disclosure, the active substance may be obtained from the hydrosol by any method known in the art or the active substance may be a synthetic analogue of the natural component or a combination thereof.

The active substances may be any component of the hydrosol. In some embodiments, the active substance is or comprises at least one aromatic compound. In some embodiments, the active substance is or comprises at least one terpene. The term terpene comprises a variety of molecules which may be classified by the number of isoprene units in the molecule, including hemiterpene, monoterpene, sesquiterpene, diterpene, sesterterpene, triterpene, sesquarterpene, tetraterpene, polyterpene or norisoprenoid. In some embodiments, the active substance comprises at least one of hemiterpene, monoterpene, sesquiterpene, diterpene, sesterterpene, triterpene, sesquarterpene, tetraterpene, polyterpene or norisoprenoid.

In some embodiments, the active substance is or comprises at least one monoterpene. In some embodiments, the monoterpene comprises a terpinene, such as α-terpinene, β-terpinene, γ-terpinene and/or δ-terpinene (a.k.a. terpinolene). In some embodiments, the monoterpene comprises a geraniol, terpineol, limonene, myrcene, linalool and/or pinene. In some embodiments, any one or more of the aforementioned compounds is present at a concentration of at least 2% by weight, and optionally at least 5%, or at least 10%, or at least 20% by weight.

Herein throughout, percentages of organic compounds described herein do not include water as part of the total amount. Thus, for example, a mixture consisting of 98% water, 1% terpinene and 1% terpineol would be considered as comprising 50% terpinene and 50% terpineol.

In some embodiments, the monoterpene comprises γ-terpinene (e.g., at a concentration of at least 5% by weight), optionally in combination with δ-2-carene, α-pinene, terpinolene (a.k.a. 6-terpinene) and/or terpinen-4-ol (e.g., at a concentration of at least 2% by weight, optionally at least 5%).

In some embodiments, the monoterpene comprises δ-2-carene (e.g., at a concentration of at least 5% by weight), optionally in combination with γ-terpinene, α-pinene, terpinolene and/or terpinen-4-ol (e.g., at a concentration of at least 2% by weight, optionally at least 5%).

In some embodiments, the monoterpene comprises α-pinene (e.g., at a concentration of at least 5% by weight), optionally in combination with δ-2-carene, γ-terpinene, terpinolene and/or terpinen-4-ol (e.g., at a concentration of at least 2% by weight, optionally at least 5%).

In some embodiments, the monoterpene comprises terpinolene (e.g., at a concentration of at least 5% by weight), optionally in combination with δ-2-carene, α-pinene, γ-terpinene and/or terpinen-4-ol (e.g., at a concentration of at least 2% by weight, optionally at least 5%).

In some embodiments, the monoterpene comprises terpinen-4-ol (e.g., at a concentration of at least 5% by weight), optionally in combination with δ-2-carene, α-pinene, terpinolene and/or γ-terpinene (e.g., at a concentration of at least 2% by weight, optionally at least 5%).

In some embodiments, the active substance is or comprises at least one sesquiterpene. In some embodiments, the sesquiterpene is humulene, farnesenes or farnesol.

In some embodiments, the active substance is or comprises at least one alkylbenzene. In some embodiments, the active substance is or comprises p-cymene, o-cymene or m-cymene. In some embodiments, the active substance is or comprises o-cymene. In some embodiments, the active substance is or comprises p-cymene.

In some embodiments, the formulation comprises at least one of γ-terpinene, δ-2-carene, o-cymene, p-cymene, α-pinene, terpinolene, and terpinen-4-ol.

The amount of the active substance in the crop protection product may vary within wide ranges. The active substance concentration may be typically from 0.0001% to 95% by weight of active substance.

In some embodiments, the formulation comprises from 5% to 95% γ-terpinene, optionally 10% to 90%, optionally from 20% to 80%, optionally from 30% to 70%, optionally from 25% to 50%, and optionally from 25% to 40%. In some of any of the aforementioned embodiments, the formulation further comprises from 10% to 25% δ-2-carene, from 10% to 25% p-cymene and/or from 10% to 25% o-cymene. In some of any of the aforementioned embodiments, the formulation further comprises α-pinene, terpinolene and/or terpinen-4-ol (e.g., at a concentration of at least 2% by weight, optionally at least 5%).

In some embodiments, the formulation comprises from 5% to 95% δ-2-carene, optionally from 10% to 90%, optionally from 10% to 80%, optionally from 10% to 70%, optionally from 10% to 50%, optionally from 10% to 40%, and optionally from 10% to 25%. In some of any of the aforementioned embodiments, the formulation further comprises from 10% to 25% γ-terpinene, from 10% to 25% p-cymene and/or from 10% to 25% o-cymene. In some of any of the aforementioned embodiments, the formulation further comprises α-pinene, terpinolene and/or terpinen-4-ol (e.g., at a concentration of at least 2% by weight, optionally at least 5%).

In some embodiments, the formulation comprises from 5% to 95% o-cymene, optionally from 10% to 90%, optionally from 10% to 80%, optionally from 10% to 70%, optionally from 10% to 50%, optionally from 10% to 40%, and optionally from 10% to 25%. In some of any of the aforementioned embodiments, the formulation further comprises from 10% to 25% γ-terpinene, from 10% to 25% p-cymene and/or from 10% to 25% δ-2-carene. In some of any of the aforementioned embodiments, the formulation further comprises α-pinene, terpinolene and/or terpinen-4-ol (e.g., at a concentration of at least 2% by weight, optionally at least 5%).

In some embodiments, the formulation comprises from 5% to 95% p-cymene, from 10% to 90%, optionally from 10% to 80%, optionally from 10% to 70%, optionally from 10% to 50%, optionally from 10% to 40%, and optionally from 10% to 25%. In some of any of the aforementioned embodiments, the formulation further comprises from 10% to 25% γ-terpinene, from 10% to 25% o-cymene and/or from 10% to 25% δ-2-carene. In some of any of the aforementioned embodiments, the formulation further comprises α-pinene, terpinolene and/or terpinen-4-ol (e.g., at a concentration of at least 2% by weight, optionally at least 5%).

In some embodiments, the formulation comprises from 5% to 95% terpinene (e.g., a total concentration of α-terpinene, β-terpinene, γ-terpinene and δ-terpinene is 5% to 95%), optionally from 5% to 90%, optionally from 5% to 70%, optionally from 5% to 50%, optionally from 5% to 40%, optionally from 5% to 25%, and optionally from 5% to 15%. In some of any of the aforementioned embodiments, the formulation further comprises from 10% to 25% δ-2-carene, from 10% to 25% p-cymene and/or from 10% to 25% o-cymene. In some of any of the aforementioned embodiments, the formulation further comprises α-pinene and/or terpinen-4-ol (e.g., at a concentration of at least 2% by weight, optionally at least 5%).

In some embodiments, the formulation comprises from 10% to 25% δ-2-carene, from 10% to 25% p-cymene, and from 10% to 50% γ-terpinene. In some of any of the aforementioned embodiments, the formulation further comprises α-pinene and/or terpinen-4-ol (e.g., at a concentration of at least 2% by weight, optionally at least 5%).

In some embodiments, the formulation comprises from 10% to 25% δ-2-carene, from 10% to 25% o-cymene, and from 10% to 50% γ-terpinene. In some of any of the aforementioned embodiments, the formulation further comprises α-pinene and/or terpinen-4-ol (e.g., at a concentration of at least 2% by weight, optionally at least 5%).

According to an aspect of some embodiments of the invention, there is provided a formulation comprising at least one organic compound, and preferably at least two, three, four or five, and optionally even more than five organic compounds, wherein the aforementioned organic compound(s) is a terpinene (e.g., α-terpinene, β-terpinene, γ-terpinene and/or δ-terpinene), geraniol, terpineol, limonene, myrcene, linalool and/or pinene. The formulation further comprises an aqueous carrier. In some embodiments, any one or more of the aforementioned compounds is present at a concentration of at least 2% by weight, and optionally at least 5%, or at least 10%, or at least 20% by weight (not including the weight of water, as discussed herein).

The organic compounds and aqueous carrier together preferably comprise a hydrosol or combination of hydrosols, e.g., according to any of the respective embodiments described herein.

The formulation according to any of the embodiments and any of the aspects described herein may comprise additional components. For example, the formulation may comprise extenders, solvents and/or solid carriers and/or further auxiliaries, such as, for example, surfactants. Suitable for use as auxiliaries are substances which are suitable for imparting to the formulation of the active compound or the application forms prepared from these formulations. Suitable extenders are, for example, water, polar and nonpolar organic chemical liquids.

In some embodiments, the formulation comprises at least one essential oil. The essential oil and the hydrosol can be from the same plant or from different plants. When an essential oil and hydrosol are from the same plant, the essential oil and hydrosol may optionally be produced by the same process (e.g., distillation) and/or the essential oil may optionally have substantially the same composition as lipophilic compounds in the hydrosol. The amount of the essential oil may vary depending on various considerations. In some embodiments, the formulation comprises from 1% to 30% essential oil, optionally from 2% to 20%, optionally from 1% to 10%, optionally from 1% to 5%, optionally from 2% to 5%, optionally from 5% to 25%, optionally from 10% to 25%. In some embodiments, the formulation comprises 1%, 2%, 3%, 4%, 5%, 6%, 7%, 8%, 9%, 9%, 10%, 15%, 20%, 25%, 30% of an essential oil.

The formulation described herein in accordance with some embodiments does not comprise a chemical pest control agent such as pesticides, insecticides or fungicides. The formulation described herein in accordance with some embodiments comprises essentially only natural components or their synthetic analogues as the active components.

According to an aspect of some embodiments of the invention, there is provided a composition-of-matter and/or an article of manufacture comprising a formulation (e.g., a liquid formulation) which comprises at least one hydrosol (according to any of the respective embodiments described herein) and a matrix (e.g., a solid matrix), for example, a polymeric matrix. At least a portion of the formulation is associated with the matrix.

Herein throughout, the phrase “associated with” (and its grammatical variants)—which may be used interchangeably with “encapsulated within”, “embedded within” and “incorporated within”—refers to a substance (e.g., hydrosol) being dissolved within (e.g., as a solid solution), dispersed within and/or attached to (e.g., adsorbed to) a surface (e.g., a surface of an internal void) of another substance (e.g., a matrix or a portion thereof) in a homogenous and/or heterogeneous manner.

Encapsulation of a hydrosol (or formulation comprising a hydrosol) includes, for example, distribution of the at least one hydrosol throughout a matrix (e.g., polymeric matrix); entrapment of the at least one hydrosol in voids within said matrix; random dispersion of at least one hydrosol within the polymeric matrix; absorption of a hydrosol by the matrix; etc. The degree and uniformity of the encapsulation may also be a result of chemical and/or physical interactions between the matrix and the at least one hydrosol. The matrix may be of any size or shape capable of holding the at least one volatile hydrosol.

In some of any of the respective embodiments, the matrix is not a polymeric fabric, e.g., a fabric in which the formulation is absorbed.

In some embodiments, the matrix comprises synthetic or semi-synthetic polymers. Non-limiting examples of synthetic polymers include poly(hydroxyalkyl methacrylate), poly(vinyl alcohol) and their copolymers, poly(ethylene oxide). Non-limiting examples of semi-synthetic polymers include cellulose ethers such as hydroxypropyl cellulose (HPC), methylcellulose (MC), hydroxypropyl methylcellulose (HPMC) and sodium carboxy methylcellulose (Na CMC).

In some embodiments, the polymeric matrix comprises a hydrophilic polymer. In some embodiments the polymeric matrix is or comprises cellulosic and non-cellulosic polymers. In some embodiments, the polymer comprises or is a superabsorbent polymer. In some embodiments, the polymer comprises or is a hydrogel. Non-limiting examples of a polymer include polyvinyl alcohol, sodium polyacrylate, and any other acrylate polymer. The ratio between the formulation and the polymeric matrix may vary depending on the type of formulation and/or matrix. In some embodiments, the ratio between volume of the formulation to weight of the polymer is 5:1 to 1000:1, optionally from 10:1 to 500:1, optionally from 20:1 to 200:1, and optionally from 30:1 to 100:1.

An article of manufacture according to any of the respective embodiments described herein may optionally have any shape, for example, being configured for serving a decorative and/or functional purpose (in addition to providing a formulation). A functional purpose may be, for example, any apparatus or components thereof used in growing plants (e.g., an agricultural and/or gardening tool), pot, water pipe and/or structure for supporting a plant. An almost unlimited number of shapes can readily be obtained, for example, by forming a matrix (e.g., according to any of the respective embodiments described herein) in a suitable shape, e.g., according to techniques known in the art.

The formulation, being effective and non-toxic can be used as an agricultural formulation (including horticultural and agronomic) for reducing damage to plant (such as crop) by eradicating, suppressing, or containing pest populations.

In accordance with some aspects, the present disclosure provides a formulation comprising at least one hydrosol for use in reducing damage to a plant.

The phrases “reducing damage to a plant” and “reducing plant damage”, which are used herein interchangeably, refer herein to an improvement in any plant growth parameter, such as improved crop yield, improved root growth, improved root size maintenance, improved root effectiveness, increase in plant height, bigger leaf blade, less dead basal leaves, greener leaf color, improved harvested fruit and/or vegetable etc. as well as reduced damage to the plant location of growth (herein referred to as part of the “surroundings”). The effect of the formulation can be evaluated for example comparing plant which are grown under the same environmental conditions such that part of the plants (same plant or neighboring plants) are treated with a formulation described herein and another part of the plants are not treated or treated with placebo or with a chemical substance.

The reduction in plant damage was suggested to be associated with reduced activity of an organism, such as a pest population, on the plant. Thus, in accordance with some further aspects, the present disclosure provides an agriculture formulation comprising at least one hydrosol for use in control of a pest population.

The term “agricultural formulation” as used herein encompasses horticultural and agronomic formulations and can be used either as repellents or by killing a part or all the pest populations and any variant thereof at all cycle stages, such as eggs etc.

The term “repelling and/or killing” (and grammatical variants thereof) refers to the complete range of reduction of damage to a crop by a pest population, including reduction in pest viability, inhibition of pest development (e.g., egg hatching and/or pest maturation), and inducing the pests to go elsewhere.

Herein, the term “repellent” encompasses prevention of development of symptoms and/or a reduction in the severity of such symptoms that will or are expected to develop upon pest activity by driving the pest populations off from the crop or the surroundings. The term treating/killing as used herein refers to ensuring the death of at least part of the pest population.

Herein, “control” of a pest and/or pest population encompasses eradicating, suppressing, or containing pests as well as eliminating part of or a whole pest population from the surroundings (loci), by repelling and/or killing pests as well as controlling future generations; extermination of a part of or a whole pest population; eliminating breeding places; exposing target environment to the repellent or pesticide (e.g., insecticide) formulation; limiting adult, larvae or pest eggs, and reducing signs of damage.

Herein, the term “pest population” encompasses an adult pest population, larval or nymph population, instar population, egg population, mixed populations, or any combinations thereof. It should be noted that the number of pests in the population may vary from one to several millions.

The pest population according with the present disclosure includes all the forms during the pest's life cycle. In addition, the pest population may comprise one or more types of pests.

The formulation described herein being non-toxic can be applied to a variety of plants, at all stages of plant development and/or plant growth. For example, the formulation can be applied in at least one vegetative stage and/or at least one reproductive stage.

Non-limiting examples of pests include:

insects and mites such as: hemipterans (e.g., heteroptera, auchenorrhyncha, sternorrhyncha or coleorrhyncha), such as whiteflies (e.g., Bemisia tabaci), beet leafhopper, and aphids (e.g., Myzus persicae); coleopterans, such as Asian longhorned beetle (e.g., Anoplophora glabripennis), Japanese beetle (e.g., Popillia japonica), pine shoot beetle (e.g., Tomicus piniperda), emerald ash borer (e.g., Agrilus planipennis), boll weevil (e.g., Anthonomus grandis), palmetto weevil (e.g., Rhynchophorus cruentatus) and pink hibiscus mealybug (e.g., Maconellicoccus hirsutus); lepidopterans, such as Spodoptera littoralis, cactus moth (e.g., Cactoblastis cactorum), European grapevine moth (e.g., Lobesia botrana), gypsy moth (e.g., Lymantria dispar dispar), light brown apple moth (e.g., Epiphyas postvittana) and pink bollworm (e.g., Pectinophora gossypiella); orthopterans, such as grasshoppers and Mormon cricket (e.g., Anabrus simplex); hymenopterans, such as ants (e.g., fire ants); and dipterans, such as fruit flies (e.g., spotted-wing drosophila, Drosophila suzukii);

nematodes such as: golden nematode (e.g., Globodera rostochiensis) and pale cyst nematode (e.g., Globodera pallida);

fungi such as: ascomycetes such as Fusarium spp. (Fusarium wilt disease), Thielaviopsis spp. (canker rot, black root rot, Thielaviopsis root rot), Verticillium spp., Magnaporthe grisea (rice blast), and Sclerotinia sclerotiorum (cottony rot); and basidiomycetes such as Ustilago spp. (smuts), Rhizoctonia spp., Phakospora pachyrhizi (soybean rust), Puccinia spp. (severe rusts of cereals and grasses), and Armillaria spp. (honey fungus species, virulent pathogens of trees);

fungus-like organisms such as: oomycetes such as Pythium spp. and Phytophthora spp.; phytomyxea such as Plasmodiophora spp. and Spongospora spp.; and phytoplasmas and spiroplasmas;

viruses, viroids, virus-like organisms and protozoa.

The formulation according to any of the respective embodiments described herein optionally comprises an effective amount of hydrosol(s) and/or compound(s) described herein, the amount being effective for repelling and/or killing one or more pests according to any of the respective embodiments described herein.

In some embodiments, the formulation may be used as a pest repellent or pest killing against Bemisia tabaci pest. Bemisia tabaci is also known as sweet potato whitefly or silverleaf whitefly.

In some embodiments, the formulation is used against the Bemisia tabaci, where the formulation comprises at least one hydrosol.

In some embodiments, the formulation may be used as a pest repellent or pest killing against such insects as the Spodoptera littoralis.

In some embodiments, the repellent or killing formulation is used against the Spodoptera littoralis, where the formulation comprises at least one hydrosol.

In some embodiments, the formulation may be used as a pest repellent or pest killing against such insects as the Myzus persicae. Myzus persicae is also known as the green peach aphid or the peach-potato aphid.

In some embodiments, the formulation is used against the Myzus persicae, where the formulation comprises at least one hydrosol.

According to an aspect of some embodiments of the invention, there is provided a method of reducing plant damage caused by pest, the method comprises applying (also referred to herein interchangeably as administering) a formulation, composition-of-matter and/or article of manufacture comprising at least one hydrosol (according to any of the respective embodiments described herein) to the pest population or to the loci or surroundings thereof, thereby reduce damage to plant (crop). In accordance with some other aspects, the present disclosure provides a method for pest population control, the method comprises applying a formulation comprising at least one hydrosol to surrounding or to the pest population or to the loci thereof. The present invention provides methods for repelling and/or killing pests.

Herein, the term “surroundings” refers to any one or more plant/crop region susceptible to damage by pest population (such as any agriculture crop grown for example in greenhouses, in forestry or in horticulture), and to the remote surroundings and which do not include any agriculturally or horticulturally desirable target. The surroundings may be for example a plant, plant part, vegetable and/or plant location of growth, leaves, bark, fruit, flowers, seeds, or roots of beans and peas such as soybean, red bean, broad bean, pea, kidney-bean, peanut, etc.; fruit trees such as apple, citrus, pear, grape, peach, plum, cherry, walnut, chestnut, almond, banana, strawberry, etc.; leafy and fruiting vegetables such as cabbage, tomato, spinach, broccoli, lettuce, onion, stone-leek, Spanish paprika, eggplant, pepper, etc.; root crops such as carrot, potato, sweet potato, taro, radish, lotus rhizome, turnip, burdock, garlic, etc.; cereals such as rice, barley, wheat, rye, oat, corn, etc.; crops such as cotton, flax, beet, hop, sugarcane, sugar beet, olive, gum, coffee, tobacco, tea, etc.; cucurbitaceous plants such as pumpkin, cucumber, muskmelon, watermelon, melon, etc.; pasture plants such as orchard grass, sorghum, timothy, clover, alfalfa, etc.; lawn grasses; perfumery crops; flowers and ornamental plants; garden-trees such as ginkgo tree, cherry tree, gold-leaf plant, etc.; and timber woods such as white fir, silver fir, pine, hatchet-leaved arbor-vitae, Japan cedar, Japanese cypress, etc. In addition, the formulation may be administrated in the form of seed coating, soil drench, spray and may be applied to the seed, the plant or to harvested fruits and vegetables or to the soil wherein the plant is growing or wherein it is desired to grow (plant's locus of growth—herein surroundings).

The formulations may be applied/administered by various routes. In some embodiments, the method comprises applying the formulation by spraying, dusting dripping or evaporation. In some embodiments, the method comprises applying the formulation in a liquid form by dripping. In some embodiments, method comprises applying the formulation in the form of an aerosol.

In some embodiments, the formulation is introduced into a fogger creating fog, optionally a homogenous fog, for example in a greenhouse.

In some embodiments, the method comprising applying the formulation associated with a matrix (e.g., in a form of a composition-of-matter and/or article of manufacture according to any of the respective embodiments described herein), preferably a polymeric matrix such as a hydrophilic polymer. The method optionally comprises applying the formulation and matrix in the vicinity of the plant (optionally in the surroundings).

In some embodiments, the method comprises administration the formulation at any point in time during crop growth and/or crop development. For example, the formulation may be administrated at leaf production, tiller production booting, heading or anthesis. In some embodiments, the method comprises administration of the formulation at least once between harvesting and sowing.

In some embodiments, the method comprises sequential administration of several formulations each comprising at least one hydrosol.

The formulation may be administrated at various protocols. In some embodiment, the method comprises applying the formulation once every few hours or days, e.g. 1 hour to at least 7 days.

In some embodiment, the method comprises multiple applications. The application times and length of interval may depend on plant species, plant pest species, etc. in some other embodiments, the method comprises applying the formulation to a plant and/or plant part for two times, during any desired development stages or under any predetermined pest pressure, at an interval of about 1 hour, about 5 hours, about 10 hours, about 24 hours, about two days, about 3 days, about 4 days, about 5 days, about 1 week, about 10 days, about two weeks, about three weeks, about 1 month or more. In some other embodiments, the method comprises applying the formulation to a plant and/or plant part for more than two times, for example, 3 times, 4 times, 5 times, 6 times, 7 times, 8 times, 9 times, 10 times, or more, during any desired development stages or under any predetermined pest pressure, at an interval of about 1 hour, about 5 hours, about 10 hours, about 24 hours, about two days, about 3 days, about 4 days, about 5 days, about week, about 10 days, about two weeks, about three weeks, about 1 month or more. The intervals between each application can vary if it is desired.

The present disclosure also encompasses sequential application of various formulations each comprising at least one hydrosol.

Furthermore, in some aspects, the present disclosure provides a kit comprising at least one formulation comprising at least one hydrosol. The kit may comprise a two-component kit comprising a first container comprising a formulation comprising at least one hydrosol and a second container comprising a polymeric matrix. Moreover, the kit may additionally comprise at least one auxiliary. The kit further comprises instructions for use of the formation in reducing plant damage and/or killing pest and/or repelling pests.

As used herein the term “about” refers to ±20%, and in optionally embodiments refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

### Preparation of Exemplary Formulations

Plant material (e.g., at least one of rosemary, tea tree, lemongrass), either a complete plant or part thereof, is steam-distilled at a temperature of at least 100° C. and the aqueous phase is collected. Different types of plant material may optionally be distilled together (to directly form a composition comprising a mixture of hydrosols), and/or distilled separately (to form different hydrosols, which may then be mixed). The following exemplary formulations are obtained:

Formulation 1 comprising rosemary hydrosol, lemongrass hydrosol, tea tree hydrosol and Azadirachta indica hydrosol;

Formulation 2 comprising rosemary hydrosol, lemongrass hydrosol, tea tree hydrosol and azedarach hydrosol; and

Formulation 3 comprising rosemary hydrosol, pine hydrosol and basil hydrosol.

### Example 2

### Characterization of an Exemplary Formulation

Characterization of the active ingredients in the formulation was done using Solid Phase MicroExtraction (SPME). Specifically, 250 ml of the formulation was incubated for a few hours with NaCl and 2-heptanone, as an internal standard reference. The sample was then analyzed using GCMS, using an Agilent GC-MSD system with a Restek RXi-5SIL MS column. Identification of the volatile ingredients was done using comparison of the results to libraries of known compounds.

The major ingredients were terpenes such as monoterpenes and sesquiterpenes, as shown in Table 1 below.

TABLE 1
Components of an exemplary formulation

| No. | compound name | percentage |
|---|---|---|
| 1 | α-Thujene | 1.13% |
| 2 | α-Pinene | 1.05% |
| 3 | α-Pinene | 5.14% |
| 4 | Camphene | 0.92% |
| 5 | Myrcene | 1.88% |
| 6 | Sabinene | 0.91% |
| 7 | β-Pinene | 0.53% |
| 8 | α-Phellandrene | 0.32% |
| 9 | α-Phellandrene | 0.74% |
| 10 | δ-2-Carene | 17.36% |
| 11 | Limonene | 1.11% |
| 12 | p-Cymene | 16.97% |
| 13 | Monoterpene | 1.40% |
| 14 | γ-Terpinene | 29.36% |
| 15 | Terpinolene | 5.22% |
| 16 | Camphor | 0.42% |
| 17 | Camphor | 0.59% |
| 18 | Terpinen-4-ol | 6.86% |
| 19 | Terpinen-4-ol | 6.85% |
| 20 | α-Terpineol | 0.14% |
| 21 | Neral | 0.22% |
| 22 | β-Fenchyl alcohol | 0.42% |
| 23 | Geranial | 0.22% |
| 24 | (E-)-Caryophyllene | 0.08% |
| 25 | Aromadendrene | 0.12% |
| 26 | Viridiflorene | 0.05% |

### Example 3

### Effect of Exemplary Formulation on Bemisia tabaci Adult Preference

One hundred B. tabaci adults (3-5-d old) were exposed for 24 hours to two cotton seedlings (kept in a rearing box), one was treated with formulation 1 (described herein) and another was untreated seedling. The number of live adults on treated and untreated plant was then determined.

After 24 hours, 1 (of 100) individuals remained on the treated seedling, whereas 65 (of 100) individuals remained on the untreated seedling.

### Example 4

### Effect of Exemplary Formulation on Bemisia tabaci Adult Mortality

Cotton seedlings treated with formulation were exposed to adult B. tabaci for 48 hrs. Mortality was then determined. Data are averages ±SEM of 5 replicates 15-18 each. Control is treatment with water. Results are shown in Table 2. Means follows by the same letter do not differ significantly at p=0.05.

TABLE 2
Effect of exemplary formulation on Bemisia tabaci adult mortality

| Formulation | No. of adults | Mortality, % ± SEM |
|---|---|---|
| Control | 82 | 6 ± 3a |
| Formulation 1 | 78 | 92 ± 4b |

### Example 5

### Effect of Exemplary Formulation on Spodoptera littoralis (First Instar)

Cotton seedlings treated with formulation were exposed to S. littoralis L.1 for 3 days. Mortality was then determined. Data are averages ±SEM of 5 replicates 9-10 larvae each. Control is treatment with water. Results are shown in Table 3. Means follows by the same letter do not differ significantly at p=0.05.

TABLE 3
Effect of exemplary formulation on Spodoptera littoralis

| Formulation | No. of L₁ | Mortality, % ± SEM |
|---|---|---|
| Control | 49 | 0a |
| Formulation 1 | 50 | 96 ± 4 |

### Example 6

### Effect of Exemplary Formulation on Myzus persicae (First Instar)

Cotton seedlings treated with formulation were placed separately in a Petri dish containing agar (to increase moisture). Ten first-instars nymphs were placed each petri dish. Mortality was then determined after 3 days. Data are averages ±SEM of 5 replicates of 10 days larvae each. Control is treatment with water. Results are shown in Table 4. Means follows by the same letter do not differ significantly at p=0.05.

TABLE 4
Effect of exemplary formulation on Myzus persicae

| Formulation | No. of aphids | Mortality, % ± SEM |
|---|---|---|
| Control | 50 | 20 ± 5a |
| Formulation 1 | 50 | 80 ± 9b |

### Example 7

### Effect of Exemplary Formulation in Matrix on Crop Growth

The experiment was done in 6 tunnels covered with polyethylene with anti-fog IR without addition of a pest UV-repellant. The tunnels' openings were covered by a 50 mesh net.

Basil was seeded in three tunnels and leaf vegetables such as cabbage, cauliflower, chard were seeded in the other three tunnels.

The crops were treated with Formulation I, associated with a sodium acrylate matrix. For comparison, control crops were treated with a commercially available a chemical pest control composition not treated with any composition.

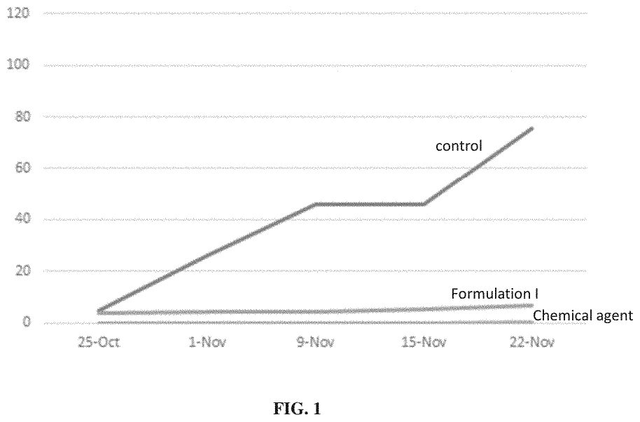

The effect of the treatments was evaluated by a well skilled supervisor. Both the basil and the chard were hardly infected and only the cabbage and the cauliflower were strongly infected by silverleaf whitefly. As such, the statistical evaluation of the results was done only on the cabbage and the cauliflower. Table 5 below and FIG. 1 show that the effect of Formulation I was as good as that of the chemical pest control composition.

TABLE 5
Number of whiteflies on cabbage following treatment
with exemplary formulation or chemical pest
control composition or without treatment

| Treatment | Day 0 | Day 7 | Day 14 | Day 21 | Day 28 |
|---|---|---|---|---|---|
| Control | 52 | 129 | 203.5 | 203.5 | 270.5 |
| Formulation I | 7.5 | 14* | 14* | 17.5* | 20* |
| Chemical | 2 | 2* | 2* | 5.5* | 6.5* |
| pest control | | | | | |
| composition | | | | | |

*p < 0.05 relative to control value

### Example 8

### Release of Exemplary Formulation from Matrix

An exemplary formulation prepared as described hereinabove was incorporated into a polymer matrix and the release profile of the formulation was evaluated by determining the amount of formulation in the matrix over the course of several weeks under ambient indoor conditions. Release of formulation by evaporation was determined by weighing the matrix at various time points.

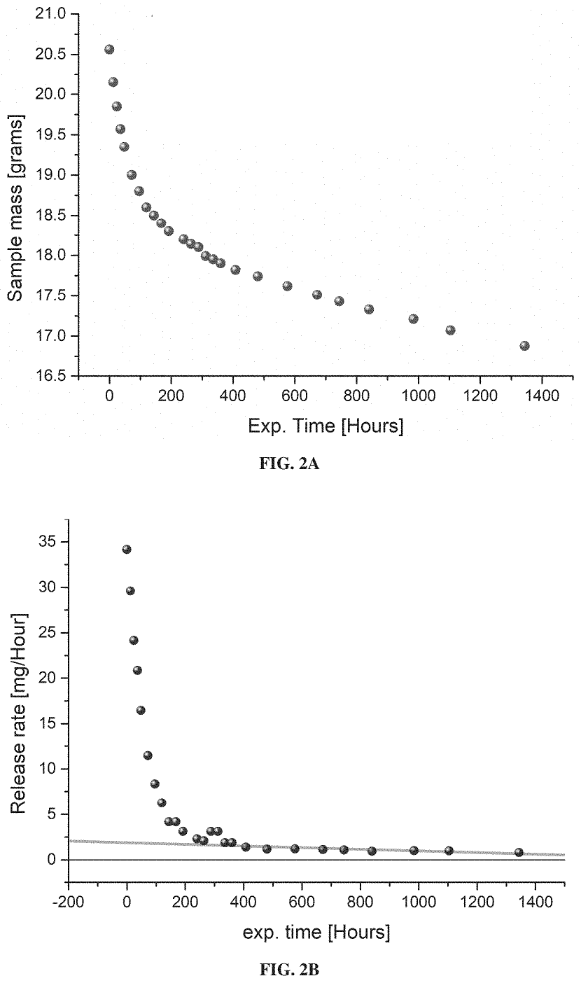

As shown in FIGS. 2A and 2B, formulation was released continuously for over 1300 hours. As further shown therein, two phases of release were observable, with rapid release occurring for about the first 200 hours, followed by more gradual long-term release.

These results indicate that the formulation can have a long-term beneficial activity (e.g., throughout the duration of a growing season) when incorporated into a suitable matrix.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1. A formulation comprising at least one hydrosol selected from the group consisting of a rosemary hydrosol, a lemongrass hydrosol, an azedarach hydrosol, an Azadirachta indica hydrosol, a tea tree hydrosol, a pine hydrosol and a basil hydrosol.

2. The formulation according to claim 1, comprising at least two hydrosols selected from the group consisting of a rosemary hydrosol, a lemongrass hydrosol, an Azadirachta indica hydrosol and a tea tree hydrosol.

3. The formulation according to claim 1, comprising at least two hydrosols selected from the group consisting of a rosemary hydrosol, a lemongrass hydrosol, an azedarach hydrosol and a tea tree hydrosol.

4. The formulation according to claim 1, comprising at least two hydrosols selected from the group consisting of a rosemary hydrosol, a pine hydrosol and a basil hydrosol.

5. The formulation according to claim 1, comprising from 10% to 80% of rosemary hydrosol, from 10% to 80% of lemongrass hydrosol, from 1% to 50% of azedarach hydrosol and from 5% to 50% of tea tree hydrosol.

6. The formulation according to claim 1, comprising from 10% to 80% of rosemary hydrosol, from 10% to 80% of lemongrass hydrosol, from 1% to 50% of Azadirachta indica hydrosol and from 5% to 50% of tea tree hydrosol.

7. The formulation according to claim 5, comprising from 10% to 50% of rosemary hydrosol, from 30% to 80% of lemongrass hydrosol, from 1% to 15% of azedarach hydrosol and from 10% to 25% of tea tree hydrosol.

8. The formulation according to claim 6, comprising from 10% to 50% of rosemary hydrosol, from 30% to 80% of lemongrass hydrosol, from 1% to 15% of Azadirachta indica hydrosol and from 10% to 25% of tea tree hydrosol.

9. The formulation according to claim 1, comprising at least one compound selected from the group consisting of γ-terpinene, δ-2-carene, p-cymene, α-pinene, terpinolene and terpinen-4-ol.

10. The formulation according to claim 9, comprising from 5% to 95% γ-terpinene.

11. The formulation according to claim 9, comprising from 5% to 95% δ-2-carene.

12. The formulation according to claim 9, comprising from 5% to 95% p-cymene.

13. The formulation according to claim 1, comprising from 1% to 30% essential oil by weight.

14. The formulation according to claim 1, being formulated for administration by spraying and/or dripping.

15. The formulation according to claim 1, being associated with a polymeric matrix.

16-18. (canceled)

19. A method of controlling a pest population, the method comprising applying to a pest population or to the loci or surroundings thereof, a formulation according to claim 1.

20. The method according to claim 19, being for repelling and/or killing a pest selected from the group consisting of ectoparasites, oomycetes, insects, mites, fungi, bacteria, viruses, virus-like organisms, nematodes, gastropods, protozoa, phytopathogens and phytoplasmas.

21. The method according to claim 19, being for repelling and/or killing a pest selected from the group consisting of Bemisia tabaci, Spodoptera littoralis and Myzus persicae.

22. A kit comprising the formulation according to claim 1.

23. The kit according to claim 22, comprising instructions for use of the formulation in control of a pest population.

24. A composition-of-matter comprising:
a formulation which comprises at least one hydrosol, and
a polymeric matrix with which at least a portion of said formulation is associated.

25. The composition-of-matter according to claim 24, wherein the formulation comprises at least one hydrosol selected from the group consisting of a rosemary hydrosol, a lemongrass hydrosol, an azedarach hydrosol, an Azadirachta indica hydrosol, a tea tree hydrosol, a pine hydrosol and a basil hydrosol.

26-28. (canceled)

29. An article of manufacture comprising the formulation according to claim 1.

30. An article of manufacture comprising the composition-of-matter according to claim 24.

31. A method of controlling a pest population, the method comprising applying to a pest population or to the loci or surroundings thereof, a composition-of-matter according to claim 24.

32. The method according to claim 31, being for repelling and/or killing a pest selected from the group consisting of ectoparasites, oomycetes, insects, mites, fungi, bacteria, viruses, virus-like organisms, nematodes, gastropods, protozoa, phytopathogens and phytoplasmas.

33. The method according to claim 31, being for repelling and/or killing a pest selected from the group consisting of Bemisia tabaci, Spodoptera littoralis and Myzus persicae.
